(19) United States
(12) Patent Application Publication
(10) Pub. No.: US 2022/0057601 A1
(43) Pub. Date: Feb. 24, 2022

(54) LENS SYSTEM, PHOTOGRAPHING APPARATUS, AND MOVING BODY

(71) Applicant: SZ DJI TECHNOLOGY CO., LTD., Shenzhen (CN)

(72) Inventors: Tatsuya NAKATSUJI, Shenzhen (CN); Shigehiko MATSUNAGA, Shenzhen (CN); Tomoko ADACHI, Shenzhen (CN)

(73) Assignee: SZ DJI TECHNOLOGY CO., LTD., Shenzhen (CN)

(21) Appl. No.: 17/469,887

(22) Filed: Sep. 9, 2021

Related U.S. Application Data
(63) Continuation of application No. PCT/CN2020/094712, filed on Jun. 5, 2020.

(30) Foreign Application Priority Data
Jun. 18, 2019 (JP) 2019-112676

(51) Int. Cl. G02B 13/00; G02B 9/08

(52) U.S. Cl. CPC G02B 13/003; G02B 9/08

(57) ABSTRACT

A lens system, a photographing apparatus, and a moving body. The lens system may consist essentially of a first lens group having positive refractive power, an aperture stop, and a second lens group having positive refractive power in order from an object side to an image side. When focusing from an infinity focus state to a close object focus state, the first lens group and the second lens group may be configured to move from the image side to the object side with a fixed interval between the first lens group and the second lens group on an optical axis. The first lens group may consist essentially of three or more lenses, which may include one or more cemented lenses and one aspherical meniscus lens with a convex surface facing the object side in order from the object side.

### CROSS-REFERENCE TO RELATED APPLICATIONS

The present application is a continuation of International Application No. PCT/CN2020/094712, filed Jun. 5, 2020, which claims priority to Japanese Patent Application No. 2019-112676, filed on Jun. 18, 2019, the entire contents of each are incorporated herein by its reference.

### TECHNICAL FIELD

The present disclosure relates to the field of imaging technology, in particular, to a lens system, a photographing apparatus, and a moving body.

### BACKGROUND

Patent Document 1 discloses an imaging lens that is a negative look-ahead lens and has a relatively small F-number and a relatively wide angle. Patent Document 2 discloses an imaging lens with a relatively small F number and a relatively wide angle.
Patent Document 1: Japanese Patent No. 5638702 Specification.
Patent Document 2: Japanese Patent No. 6111798 Specification.

### SUMMARY

One example of the present disclosure provides a lens system. The lens system may consist essentially of a first lens group having positive refractive power, an aperture stop, and a second lens group having positive refractive power in order from an object side to an image side. When focusing from an infinity focus state to a close object focus state, the first lens group and the second lens group may be configured to move from the image side to the object side with a fixed interval between the first lens group and the second lens group on an optical axis. The first lens group may consist essentially of three or more lenses, which may include one or more cemented lenses and one aspherical meniscus lens with a convex surface facing the object side in order from the object side. The second lens group may consist essentially of more than four lenses, which may include one or more cemented lens and one aspherical meniscus lens with a concave surface facing the object side in order from the object side. The lens system may satisfy Conditional Expressions 1 and 2:

0.5<f/f1<1.1 (Conditional Expression 1),

1.9<TL/Y<2.4 (Conditional Expression 2).

wherein f is a focal length of the lens system; f1 is a focal length of the first lens group; TL is a distance on the optical axis from a lens surface closest to the object side of the first lens group to an imaging plane in the infinite focus state with a back focal length being in air conversion length; and Y is a maximum image height.

Another example of the present disclosure provides a photographing apparatus, which includes the lens system according to one embodiment of the present disclosure and an imaging unit.

Another example of the present disclosure provides a moving body including the lens system according to one embodiment of present disclosure and the moving body is configured to move.

### BRIEF DESCRIPTION OF THE DRAWINGS

In order to explain technical features of embodiments of the present disclosure more clearly, drawings used in the present disclosure are briefly introduced as follow. Obviously, the drawings in the following description are some exemplary embodiments of the present disclosure. Ordinary person skilled in the art may obtain other drawings and features based on these disclosed drawings without creative work.

FIG. 1 shows a lens structure, an optical member F, and an imaging plane IMA of a lens system according to the first embodiment of the present disclosure;

FIG. 2 shows spherical aberration, astigmatism, and distortion aberration of the lens system in an infinite focus state according to the first embodiment of the present disclosure;

FIG. 3 shows a lens structure, an optical member F, and an imaging surface IMA of a lens system according to the second embodiment of the present disclosure;

FIG. 4 shows spherical aberration, astigmatism, and distortion aberration of the lens system in an infinite focus state according to the second embodiment of the present disclosure;

FIG. 5 shows a lens structure, an optical member F, and an imaging surface IMA of a lens system according to the third embodiment of the present disclosure;

FIG. 6 shows spherical aberration, astigmatism, and distortion aberration of the lens system in an infinite focus state according to the third embodiment of the present disclosure;

FIG. 7 shows a lens structure, an optical member F, and an imaging surface IMA of a lens system according to the fourth embodiment of the present disclosure;

FIG. 8 shows spherical aberration, astigmatism, and distortion aberration of the lens system in an infinite focus state according to the fourth embodiment of the present disclosure;

FIG. 9 schematically shows an example of a moving body system including an unmanned aerial vehicle (UAV) and a controller according to one embodiment of the present disclosure;

FIG. 10 shows an example of functional blocks of an UAV according to one embodiment of the present disclosure;

FIG. 11 is an external perspective view of a stabilizer according to one embodiment of the present disclosure.

### DETAILED DESCRIPTION

In order to make objectives, technical solutions, and advantages of embodiments of the present disclosure clearer, the technical solutions in the embodiments of the present disclosure will be described clearly and completely in conjunction with the accompanying drawings in the embodiments of the present disclosure. Obviously, the described embodiments are part of the embodiments of the present disclosure, rather than all of the embodiments. Based on the embodiments of the present disclosure, all other embodiments obtained by those of ordinary skill in the art without creative work shall fall within protection scope of the present disclosure. In the case of no conflict, the following embodiments and features in the embodiments may be recombined with one another.

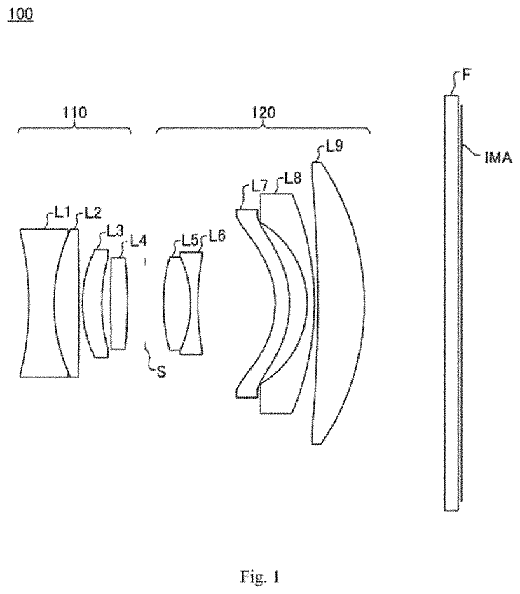

Some embodiments of the present disclosure provide a lens system in conjunction with FIGS. 1 to 8. The lens system according to one embodiment of the present disclosure includes, in order from the object side to the image side: a positive first lens group, an aperture stop, and a positive second lens group. The positive first lens group refers to a first lens group having positive refractive power. The positive second lens group refers to a second lens group having positive refractive power. When focusing from an infinity focus state to a close object focus state, the first lens group and the second lens group may move from the image side to the object side in a state where a distance between the first lens group and the second lens group on the optical axis is fixed. The first lens group includes three or more lenses, including, in order from the object side, one or more cemented lenses and one lens with a meniscus aspherical shape convex toward the object side. The second lens group includes four or more lenses, including, in order from the object side, one or more cemented lenses and one lens having a meniscus aspherical shape recessed toward the object side. The lens system according to one embodiment of the present disclosure satisfies the following Conditional Expressions:

0.5<f/f1<1.1 (Conditional Expression 1)

1.9<TL/Y<2.4 (Conditional Expression 2)

Among them, f is a focal length of the entire lens system; f1 is a focal length of the first lens group; TL is a distance on the optical axis from the lens surface closest to the object side of the first lens group to the imaging plane in the infinite focus state with a back focal length being in air conversion length; and Y is a maximum image height.

The back focus length being in air conversion length refers to the distance (air conversion distance) from a lens surface at the most image side of the lens system to the imaging plane. In the case that optical elements such as filters, glass covers, and the like, having no refractive power are arranged in between the lens surface at the most image side and the imaging plane, the back focus which has been subjected to the air conversion is obtained by air-converting the thickness of the optical elements.

By adopting the above structure, each lens can effectively share correction of on-axis and off-axis aberrations on each surface while maintaining a shorter back focus relative to a size of an imaging sensor. In addition, in a lens structure with a short back focal length, since the incident angle to each lens surface becomes large, and a deflection angle caused by the incidence and exit angles of the lens causes a large amount of aberrations. Consequently, various aberrations are likely to become large. In contrast, according to the lens system of one embodiment of the present disclosure, since the aspheric lenses of the first lens group and the second lens group are arranged substantially symmetrically, it is possible to effectively correct aspheric aberrations while suppressing various aberrations.

Conditional Expression 1 defines a ratio of the refractive power of the first lens group to the entire lens system. If the upper limit of Conditional Expression 1 is exceeded, the refractive power of the first lens group is relatively enhanced. Although this contributes to miniaturization, correction of off-axis aberrations may become difficult. On the other hand, if the lower limit of the Conditional Expression 1 is exceeded, the refractive power of the first lens group is relatively weakened, which leads to an increase in the size of the lens. In order to improve performance while maintaining a small size, it is required to increase sensitivity of each lens, which increases manufacturing difficulty.

In addition, by satisfying the following Conditional Expression 1-1, the above-mentioned effect is made more remarkable:

0.65<f/f1<1.0 (Conditional Expression 1-1)

Conditional Expression 2 defines the relationship between the total length of the lens system and the maximum image height when focusing on an infinite subject. If the upper limit of Conditional Expression 2 is exceeded, although it is advantageous for aberration correction, it is difficult to shorten the total length of the lens system. On the other hand, if the lower limit of the Conditional Expression 2 is exceeded, the total length of the lens system relative to the maximum image height becomes shorter, and it is difficult to maintain aberration performance.

In addition, by satisfying the following Conditional Expression 2-1, the above-mentioned effect is made more remarkable:

2.1<TL/Y<2.3 (Conditional Expression 2-1)

The lens system of this embodiment may further satisfy the following Conditional Expression 3:

1.3<EPD/Y<1.7 (Conditional Expression 3)

Among them, EPD is an exit pupil distance and Y is the maximum image height.

Conditional Expression 3 defines the relationship between the exit pupil position and the maximum image height when focusing on an infinite subject. If the upper limit of Conditional Expression 3 is exceeded, since the exit pupil position is far from the imaging surface, it is difficult to miniaturize the overall length. On the other hand, if the lower limit of the Conditional Expression 3 is exceeded, since the exit pupil distance is too short with respect to the maximum image height, the incident angle of off-axis rays increases, and off-axis aberration is likely to occur. In addition, because the incident angle of the imaging element is deviated from the limitation, it is easy to cause the surrounding dimming.

In addition, by satisfying the Conditional Expression 3-1, the above-mentioned effect can be made more remarkable.

1.4<EPD/Y<1.6 (Conditional Expression 3-1)

The lens system of this embodiment may further satisfy Conditional Expression 4 and Conditional Expression 5:

|f/f1_1asp|<1.0 (Conditional Expression 4)

|f/f2asp|<1.0 (Conditional Expression 5)

Wherein, f_1asp is a focal length of the lens having the meniscus aspheric shape included in the first lens group; f_2asp is a focal length of the lens having the meniscus aspheric shape included in the second lens group.

Conditional Expression 4 and Conditional Expression 5 define the relationship between the focal length of the entire system, the focal length of the aspheric lens of the first lens group, and the focal length of the aspheric lens of the second lens group. If the upper limits of Conditional Expression 4 and Conditional Expression 5 are exceeded, the refractive power of the aspheric lens of each lens group is too strong. Accordingly, the substantially symmetrical system configuration is destroyed, and aberration correction becomes difficult. In addition, the eccentric sensitivity of the aspherical portion becomes higher, and the manufacturing difficulty becomes higher.

In addition, by satisfying Conditional Expression 4-1 and Conditional Expression 5-1, the above effect is more remarkable:

|f/f_1asp|<0.8 (Conditional Expression 4-1)

|f/f_2asp|<0.6 (Conditional Expression 5-1)

The lens system of this embodiment may further satisfy Conditional Expression 6:

|CR_r1/CR_r2|>5 (Conditional Expression 6)

Wherein, CR_r1 is a radius of curvature of an object side of a lens closest to the image side of the first lens group; and CR_r2 is a radius of curvature of an image side of the lens closest to the image side of the first lens group.

If the lower limit of Conditional Expression 6 is exceeded, the balance between spherical aberration and curvature of field will be broken, and aberration correction will become difficult. In addition, performance degradation at the time of eccentricity becomes greater.

In addition, by satisfying Conditional Expression 6-1, the above-mentioned effect is made more remarkable.

|CR_r1/CR_r2|>10 (Conditional Expression 6-1)

In addition, when the expression “consisting essentially of ˜” is used in this specification, it means that in addition to the listed components, it can include substantially non-refractive lenses, apertures, filters, and glass covers, and other substantially non-lens optical elements that have substantially refractive power, and/or mechanical components such as lens flanges, imaging elements and shake correction mechanisms. For example, when the term “consisting essentially of X” is used, it means that on the basis of X, non-lens optical elements having substantially refractive power and/or mechanical components may be included.

Hereinafter, the lens structure of an example related to one embodiment of the lens system will be described. First, meaning of symbols used in description of each embodiment of the lens system will be described.

“Lm” represents a lens. Among them, m after L is a natural number. m represents the m-th lens from the object side. In each embodiment, Lm is a symbol assigned to indicate the m-th lens from the object side. In the description of each embodiment, it does not mean that the lens to which the symbol Lm is assigned is the same lens as the lens to which the same symbol Lm is assigned in other embodiments.

The plurality of surfaces of the lens system are identified by the natural number i as the surface number i. From the object side, the first surface of the optical element is set as the first surface, and then the surface numbers are added in the order in which light ray passes through the surfaces of the optical elements. “STO” in the surface number represents an opening surface of the aperture stop S. “Di” represents a distance on the optical axis between the i-th surface and the i+1-th surface.

Sometimes the lens system includes a lens having a lens surface formed as an aspheric surface. The surface number of the lens surface formed as an aspherical surface is indicated by “*”. The aspheric shape is defined by the following formula, where “x” is a distance from the apex of the lens surface in the direction of the optical axis; “y” is a height from the optical axis in a direction perpendicular to the optical axis; “c” is a paraxial curvature at the apex of the lens; “κ” is a conic constant (cone constant); “A”, “B”, “C”, and “D” are respectively the 4th, 6th, 8th, 10th-order aspheric coefficients.

x=cy2/(1+(1−(1+κ)c2y2)½)+Ay4+By6+Cy8+Dy10

In addition, “x” is also referred as an amount of sag. “y” is also referred as an image height. “C” is a reciprocal of a radius of curvature.

“f” represents focal length. “Fno” represents the F number. “ω” represents a half angle of view. “Y” represents the maximum image height (IH). “Dex” represents an exit pupil position in the infinite focus state. “R” represents the radius of curvature. In the radius of curvature shown in the lens data, “INF” represents a plane. “Nd” represents refractive index. “Vd” represents Abbe number. The refractive index Nd and Abbe number Vd are values on the d-line (λ=587.6 nm).

FIG. 1 shows lens structure, an optical member F, and an image plane IMA of the lens system 100 according to the first embodiment of the present disclosure. The lens system 100 consists essentially of a first lens group 110 having a positive refractive power, an aperture stop S, and a second lens group 120 having a positive refractive power in order from the object side. The first lens group 110, the aperture stop S, and the second lens group 120 can move in the optical axis direction as a whole to perform focusing. When focusing from the infinity focus state to the close object focus state, the first lens group 110 and the second lens group 120 move from the image side to the object side with a fixed interval therebetween on the optical axis.

The first lens group 110 consists essentially of a cemented lens obtained by cementing a negative lens L1 and a positive lens L2, a positive lens L3, and a positive lens L4. The second lens group 120 consists essentially of a cemented lens that cements a positive lens L5 and a negative lens L6, a negative lens L7, a negative lens L8, and a positive lens L9. The optical member F is provided between the lens system 100 and the image plane IMA. For example, the optical member F is a filter, a cover plate, or the like. The light passing through the lens system 100 and the optical member F is incident on the image plane IMA. The term “positive lens” refers to a lens having positive refractive power. The term “negative lens” refers to a lens having negative refractive power.

Table 1 shows lens data of the lens system 100 according to one embodiment of the present disclosure. In Table 1, Di, Nd, and Vd are shown corresponding to the surface number (SN) i. The surface interval Di of the surface number 17 is a value when focusing at infinity.

TABLE 1

| SN | R | Di | Nd | Vd |
|---|---|---|---|---|
| 1 | −41.048 | 3.471 | 1.64769 | 33.84 |
| 2 | 24.129 | 3.439 | 1.65844 | 50.85 |
| 3 | −999.416 | 0.500 | | |
| 4* | 17.563 | 2.678 | 1.85135 | 40.10 |
| 5* | 25.968 | 1.255 | | |
| 6 | 651.860 | 2.287 | 1.90366 | 31.31 |
| 7 | −64.544 | 2.500 | | |
| STO | INF | 2.500 | | |
| 9 | 24.428 | 3.762 | 1.62041 | 60.34 |
| 10 | −15.136 | 1.000 | 1.58144 | 40.89 |
| 11 | 35.470 | 10.772 | | |
| 12* | −12.921 | 2.000 | 1.85135 | 40.10 |
| 13* | −14.330 | 2.416 | | |
| 14 | −12.924 | 1.000 | 1.59270 | 35.45 |
| 15 | −38.903 | 0.500 | | |
| 16 | −194.401 | 6.434 | 1.80450 | 35.45 |
| 17 | −34.924 | 11.137 | | |
| 18 | INF | 1.850 | 1.51680 | 64.17 |
| 19 | INF | 0.500 | | |
| 20 | INF | 0.500 | | |

Table 2 shows surface numbers, conic constant κ, and spheric coefficients A, B, C, and D of the surfaces having the aspheric shape of the lens system 100 according to one embodiment of the present disclosure. Regarding the values of the conic constant κ and the aspheric coefficients A, B, C, and D, “E-i” represents an exponential expression with a base of 10, that is, “10-i”. Among them, i is an integer.

TABLE 2

| SN | K | A | B | C | D |
|---|---|---|---|---|---|
| 4 | 0 | 9.012383E−06 | 5.965115E−08 | 5.325365E−10 | 4.104448E− |
| | | | | | 12 |
| 5 | 0 | 3.120840E−05 | 9.322345E−08 | 1.664094E−09 | −2.172365E− |
| | | | | | 12 |
| 12 | 0 | −9.558084E−06 | 3.707987E−07 | 1.588494E−09 | 1.839615E− |
| | | | | | 11 |
| 13 | 0 | 8.589075E−06 | 1.648185E−07 | 2.482105E−09 | 3.805681E− |
| | | | | | 12 |

Table 3 shows focal length f, Fno, half angle of view ω, maximum image height Y, and exit pupil position Dex of the entire system of the lens system 100 in the infinite focus state according to one embodiment of the present disclosure.

TABLE 3

| | |
|---|---|
| f | 43.92 |
| Fno | 4.04 |
| ω | 32.07 |
| Y | 27.5 |
| Dex | −40.83 |

The first lens group 110 consists essentially of a cemented lens having negative refractive power combining a double-concave negative lens L1 and a positive lens L2, a positive aspheric meniscus lens L3 with a convex surface facing the object side, and a positive lens L4 having a shape with a larger radius of curvature on the object side than the image side. According to this configuration, the negative component comes first. Accordingly, in a lens system with a small lens diameter, spherical aberration and off-axis aberration may be well corrected. In addition, a glass material with a large Abbe number than that of the negative lens L1 of the cemented lens is used for the positive lens L2 of the cemented lens. Accordingly, the axial chromatic aberration and the off-axis chromatic aberration may be well corrected.

The second lens group 120 consists essentially of a cemented lens having a positive refractive power combining a biconvex positive lens L5 and a biconcave negative lens L6, a negative aspheric meniscus lens L7 with a concave surface facing the object side, a negative meniscus lens L8 with a concave surface facing the object side and a positive meniscus lens L9 with a concave surface facing the object side. By providing the cemented lens near the aperture stop S and using an aspheric meniscus lens, it is possible to appropriately correct aberrations for light of each angle of view, and to correct axial aberrations and off-axis aberrations in a balanced manner. In addition, by using a glass material with a larger Abbe number than that of the negative lens L6 of the cemented lens for the positive lens L5 of the cemented lens, the on-axis chromatic aberration and off-axis chromatic aberration may be well corrected.

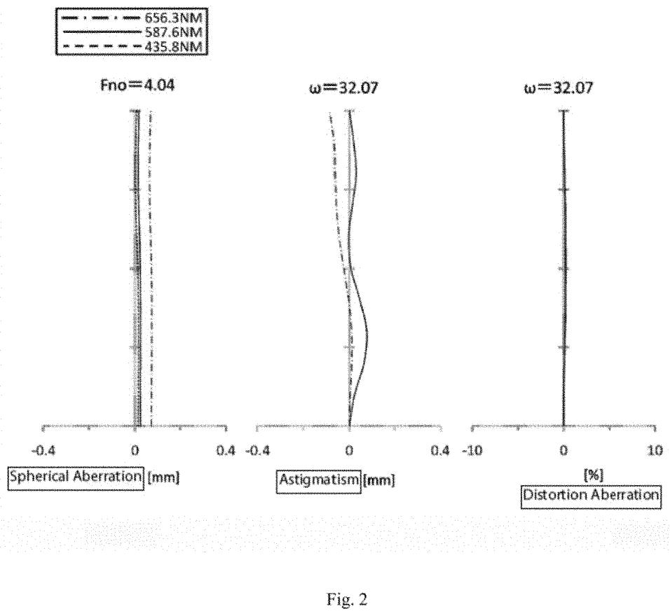

FIG. 2 shows spherical aberration, astigmatism, and distortion aberration in the infinite focus state of the lens system 100 according to one embodiment of the present disclosure. In spherical aberration, the dash-dotted line represents the value of the C line (656.27 nm), the solid line represents the value of the d line (587.56 nm), and the dotted line represents the value of the g line (435.84 nm). In astigmatism, the solid line represents the value of the sagittal image surface of the d-line, and the dash-dotted line represents the value of the meridian image surface of the d-line. The distortion aberration represents the value of the d-line. From the various aberration diagrams, it is obvious that various aberrations in the lens system 100 are well corrected and have excellent imaging performance.

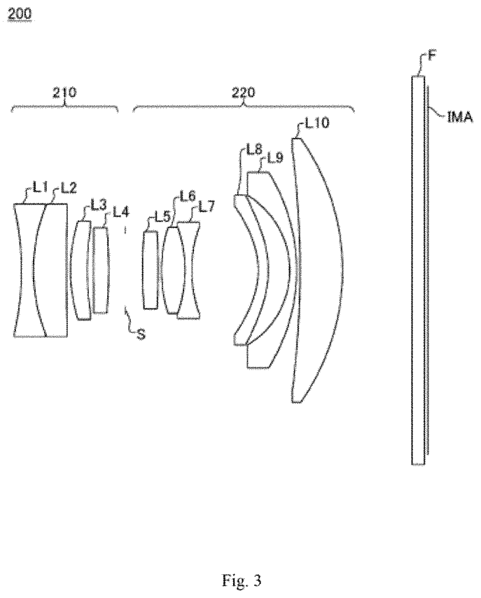

FIG. 3 also shows lens structure, an optical member F, and an image surface IMA of a lens system 200 according to the second embodiment of the present application. The lens system 200 consists essentially of a first lens group 210 having a positive refractive power, an aperture stop S, and a second lens group 220 having a positive refractive power in order from the object side. The first lens group 210, the aperture stop S, and the second lens group 220 can move in the optical axis direction as a whole to perform focusing. When focusing from the infinity focus state to the close object focus state, the first lens group 210 and the second lens group 220 may move from the image side to the object side with a fixed interval therebetween on the optical axis.

The first lens group 210 consists essentially of a cemented lens in which a negative lens L1 and a positive lens L2 are cemented, a positive lens L3, and a positive lens L4. The second lens group 220 consists essentially of a cemented lens in which a positive lens L5, a positive lens L6, and a negative lens L7 are cemented, a negative lens L8, a negative lens L9, and a positive lens L10. The optical member F is provided between the lens system 200 and the image plane IMA. For example, the optical member F is a filter, a cover plate, or the like. The light passing through the lens system 200 and the optical member F is incident on the image plane IMA.

Table 4 shows lens data of the lens system 200 according to one embodiment of the present disclosure. In Table 4, Di, Nd, and Vd are shown corresponding to the surface number i. The surface interval Di of the surface number 19 is the value when focusing at infinity.

TABLE 4

| SN | R | Di | Nd | Vd |
|---|---|---|---|---|
| 1 | −42.266 | 1.764 | 1.64769 | 33.84 |
| 2 | 25.596 | 4.884 | 1.65844 | 50.85 |
| 3 | 481.939 | 0.553 | | |
| 4* | 21.931 | 2.486 | 1.85135 | 40.10 |
| 5* | 36.378 | 0.929 | | |
| 6 | 726.302 | 2.245 | 1.90366 | 31.31 |
| 7 | −71.911 | 2.500 | | |
| STO | INF | 2.500 | | |
| 9 | 69.052 | 2.295 | 1.62041 | 60.34 |
| 10 | −134.899 | 0.500 | | |
| 11 | 21.711 | 3.462 | 1.62041 | 60.34 |
| 12 | −19.675 | 1.000 | 1.58144 | 40.89 |
| 13 | 19.279 | 9.859 | | |
| 14* | −12.056 | 1.500 | 1.85135 | 40.10 |
| 15* | −14.758 | 3.159 | | |
| 16 | −12.999 | 1.000 | 1.59270 | 35.45 |
| 17 | −27.583 | 0.500 | | |
| 18 | −141.431 | 6.285 | 1.80450 | 39.64 |
| 19 | −34.079 | 10.230 | | |
| 20 | INF | 1.850 | 1.51680 | 64.17 |
| 21 | INF | 0.500 | | |
| 22 | INF | 0.000 | | |

Table 5 shows surface numbers, conic constant κ, and aspheric coefficients A, B, C, and D of the surfaces having an aspherical shape of the lens system 200 according to one embodiment of the present disclosure. Regarding the values of the conic constant κ and the aspheric coefficients A, B, C, and D, “E-i” represents an exponential expression with a base of 10, that is, “10-i”. Among them, i is an integer.

TABLE 5

| SN | K | A | B | C | D |
|---|---|---|---|---|---|
| 4 | 0 | −2.887757E−05 | −2.513719E−07 | −6.886484E−10 | −5.769160E− |
| | | | | | 12 |
| 5 | 0 | −1.906549E−05 | −2.985467E−07 | 1.019584E−10 | −1.225721E− |
| | | | | | 11 |
| 14 | 0 | 8.829368E−05 | 1.116987E−06 | −1.114277E−08 | 4.896112E− |
| | | | | | 11 |
| 15 | 0 | 8.005222E−05 | 6.703712E−07 | −5.660545E−09 | 1.834284E− |
| | | | | | 11 |

Table 6 shows focal length f, Fno, half angle of view ω, maximum image height Y, and exit pupil position Dex of the entire system of the lens system 200 in the infinite focus state according to one embodiment of the present disclosure.

TABLE 6

| | |
|---|---|
| f | 43.46 |
| Fno | 4.08 |
| ω | 32.25 |
| Y | 27.5 |
| Dex | −40.73 |

The first lens group 210 consists essentially of a cemented lens having negative refractive power cementing a double-concave negative lens L1 and a positive lens L2, a positive aspheric meniscus lens L3 with a convex surface facing the object side, and a positive lens L4 having a shape with a larger radius of curvature on the object side than the image side. According to this configuration, the negative component comes first. As such, in a lens system with a small lens diameter, spherical aberration and off-axis aberration may be well corrected. In addition, by using a glass material whose Abbe number is larger than that of the negative lens L1 of the cemented lens for the positive lens L2 of the cemented lens, the axial and off-axis chromatic aberration may be well corrected.

The second lens group 220 consists essentially of a cemented lens having positive refractive power cementing a double-convex positive lens L5, a double-convex positive lens L6 and a double-concave negative lens L7, a negative aspheric meniscus lens L8 with a concave surface facing the object side, a negative meniscus lens L9 with a concave surface facing the object side, and a positive meniscus lens L10 with a concave surface facing the object side. By arranging the biconvex positive lens L5 near the aperture stop S, the refractive power of the cemented lens can be divided. As a result, sensitivity can be suppressed, which may contribute to reduce aberrations caused by manufacturing errors. In addition, by using the aspheric meniscus lens L8, it is possible to appropriately correct aberrations for light of each viewing angle, and it is also possible to correct the on-axis aberrations and off-axis aberrations in a balanced manner. In addition, by using a glass material having a larger Abbe number than that of the negative lens L7 of the cemented lens for the positive lens L6 of the cemented lens, the axial and off-axis chromatic aberration may be well corrected.

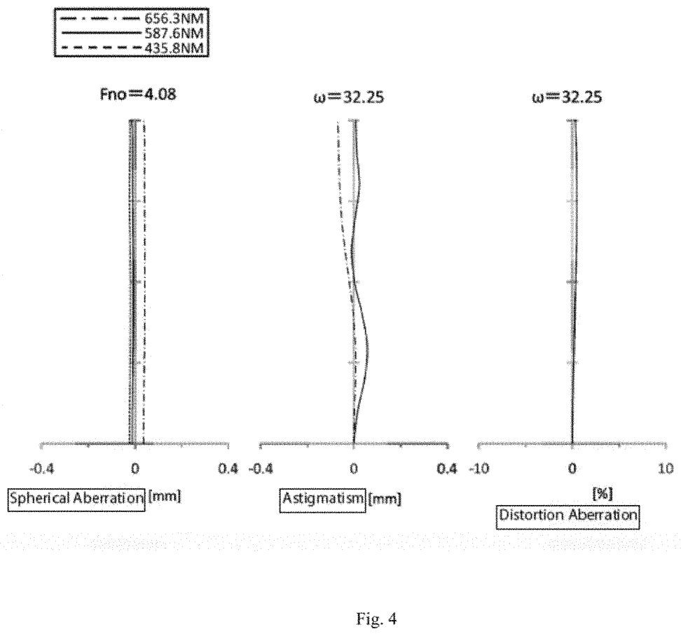

FIG. 4 shows spherical aberration, astigmatism, and distortion aberration in the infinite focus state of the lens system 200 according to one embodiment of the present disclosure. In spherical aberration, the dash-dotted line represents the value of the C line (656.27 nm), the solid line represents the value of the d line (587.56 nm), and the dotted line represents the value of the g line (435.84 nm). In astigmatism, the solid line represents the value of the sagittal image surface of the d-line, and the dash-dotted line represents the value of the meridional image surface of the d-line. The distortion aberration represents the value of the d-line. From the various aberration diagrams, it is obvious that various aberrations in the lens system 200 according to one embodiment of the present disclosure are well corrected and the lens system 200 has excellent imaging performance.

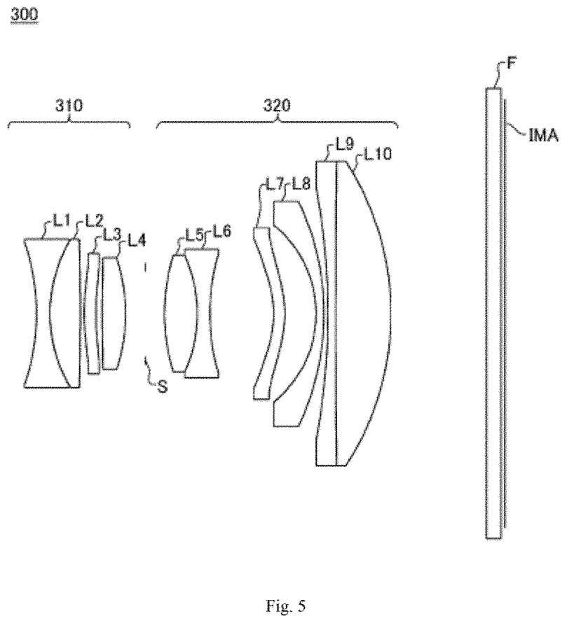

FIG. 5 also shows lens structure, an optical member F, and an image surface IMA of the lens system 300 according to the third embodiment of the present disclosure. The lens system 300 consists essentially of a first lens group 310 having a positive refractive power, an aperture stop S, and a second lens group 320 having a positive refractive power in order from the object side. The first lens group 310, the aperture stop S, and the second lens group 320 can move in the optical axis direction as a whole to perform focusing. When focusing from the infinity focus state to the close object focus state, the first lens group 310 and the second lens group 320 may move from the image side to the object side with a fixed interval therebetween on the optical axis.

The first lens group 310 consists essentially of a cemented lens in which a negative lens L1 and a positive lens L2 are cemented, a positive lens L3, and a positive lens L4. The second lens group 320 consists essentially of a cemented lens in which a positive lens L5 and a negative lens L6 are cemented, a negative lens L7, a negative lens L8, and a cemented lens in which a negative lens L9 and a positive lens L10 are cemented. The optical member F is provided between the lens system 300 and the image plane IMA. For example, the optical member F is a filter, a cover plate, or the like. The light passing through the lens system 300 and the optical member F is incident on the image plane IMA.

Table 7 shows lens data of the lens system 300 according to one embodiment of the present disclosure. In Table 7, Di, Nd, and Vd are shown corresponding to the surface number i. The surface interval Di of the surface number 18 is a value when focusing at infinity.

TABLE 7

| SN | R | Di | Nd | Vd |
|---|---|---|---|---|
| 1 | −28.225 | 1.749 | 1.67270 | 32.17 |
| 2 | 18.665 | 3.871 | 1.90366 | 31.31 |
| 3 | −276.960 | 0.500 | | |
| 4* | 28.733 | 1.500 | 1.85135 | 40.10 |
| 5* | 34.297 | 0.805 | | |
| 6 | 235.159 | 2.970 | 1.49700 | 81.61 |
| 7 | −23.283 | 2.500 | | |
| STO | INF | 2.500 | | |
| 9 | 25.422 | 4.192 | 1.65844 | 50.85 |
| 10 | −18.114 | 1.615 | 1.60342 | 38.01 |
| 11 | 27.403 | 8.168 | | |
| 12* | −13.003 | 1.414 | 1.85135 | 40.10 |
| 13* | −14.907 | 4.059 | | |
| 14 | −14.510 | 1.000 | 1.67270 | 32.17 |
| 15 | −33.548 | 0.500 | | |
| 16 | −88.598 | 1.000 | 1.67270 | 32.17 |
| 17 | 1777.846 | 7.076 | 1.90366 | 31.31 |
| 18 | −35.898 | 12.250 | | |
| 19 | INF | 1.850 | 1.51680 | 64.17 |
| 20 | INF | 0.500 | | |
| 21 | INF | 0.000 | | |

Table 8 shows surface numbers, conic constant κ, and aspheric coefficients A, B, C, and D of the surfaces having the aspheric shape of the lens system 300 according to one embodiment of the present disclosure. Regarding the values of the conic constant κ and the aspheric coefficients A, B, C, and D, “E-i” represents an exponential expression with a base of 10, that is, “10-i”. Among them, i is an integer.

TABLE 8

| SN | K | A | B | C | D |
|---|---|---|---|---|---|
| 4 | 0 | −1.080558E−04 | −9.226342E−07 | −2.234997E−09 | 5.043859E−11 |
| 5 | 0 | −9.335328E−05 | −9.867443E−07 | 9.281796E−10 | 4.215635E−11 |
| 12 | 0 | 1.867752E−04 | 1.204329E−06 | −1.790357E−08 | 7.093948E−11 |
| 13 | 0 | 1.641269E−04 | 1.098956E−06 | −1.325460E−08 | 4.426935E−11 |

Table 9 shows focal length f, Fno, half angle of view co, maximum image height Y, and exit pupil position Dex of the entire system of the lens system 300 in the infinite focus state according to one embodiment of the present disclosure.

TABLE 9

| | |
|---|---|
| f | 44.82 |
| Fno | 4.09 |
| ω | 31.53 |
| Y | 27.5 |
| Dex | −43.64 |

The first lens group 310 consists essentially of a cemented lens having negative refractive power cementing a double-concave negative lens L1 and a positive lens L2, a positive aspheric meniscus lens L3 with a convex surface facing the object side, and a positive lens L4 having a shape with a larger radius of curvature on the object side than the image side. According to this configuration, the negative component comes first. Accordingly, in a lens system with a small lens diameter, spherical aberration and off-axis aberration may be well corrected. By using a glass material with a larger Abbe number than that of the negative lens L1 of the cemented lens as the positive lens L2 of the cemented lens, the axial chromatic aberration and the off-axis chromatic aberration may be well corrected.

The second lens group 320 consists essentially of a cemented lens having positive refractive power that combines a biconvex positive lens L5 with a biconcave negative lens L6, a negative aspheric meniscus lens L7 with a concave surface facing the object side, a negative meniscus lens L8 with a concave surface facing the object side, a cemented lens having positive refractive power combining a double-concave negative lens L9 and a double-convex positive lens L10. The refractive power is divided by the negative meniscus lenses L7 and L8 with the concave surfaces facing the object side. The lens closest to the image side of the second lens group 320 is a cemented lens having positive refractive power combining the biconcave negative lens L9 and the biconvex positive lens L10. This configuration helps to reduce as much as possible the aberration caused by the deflection angle of each negative lens, and to reduce the aberration of the second lens group 320 as a whole. In addition, by using the aspheric meniscus lens L7, it is possible to appropriately correct aberrations for light of each viewing angle, and it is possible to correct the on-axis aberrations and off-axis aberrations in a balanced manner. In addition, by using a glass material whose Abbe number is larger than that of the negative lens L6 of the cemented lens for the positive lens L5 of the cemented lens, the axial chromatic aberration and the off-axis chromatic aberration can be well corrected.

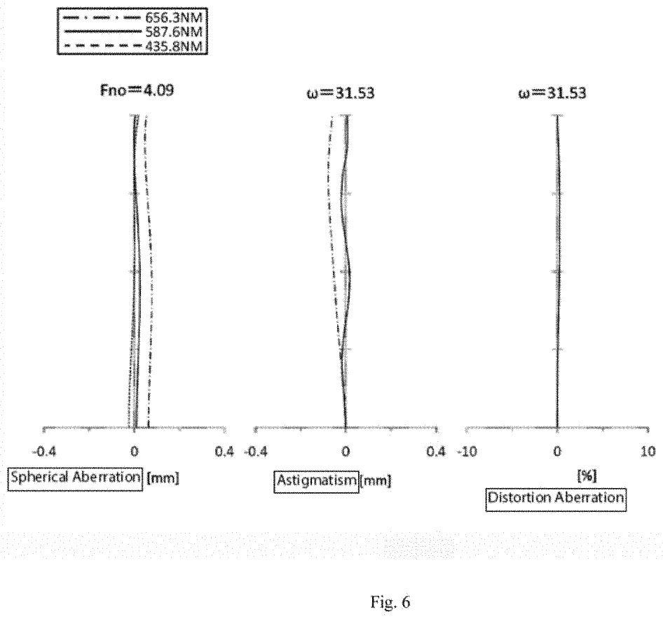

FIG. 6 shows spherical aberration, astigmatism, and distortion aberration of the lens system 300 in the infinite focus state according to one embodiment of the present disclosure. In spherical aberration, the dash-dotted line represents the value of the C line (656.27 nm), the solid line represents the value of the d line (587.56 nm), and the dotted line represents the value of the g line (435.84 nm). In astigmatism, the solid line represents the value of the sagittal image surface of the d-line, and the dash-dotted line represents the value of the meridian image surface of the d-line. The distortion aberration represents the value of the d-line. From the various aberration diagrams, it is obvious that various aberrations in the lens system 300 according to one embodiment of the present disclosure are well corrected and the lens system 300 has excellent imaging performance.

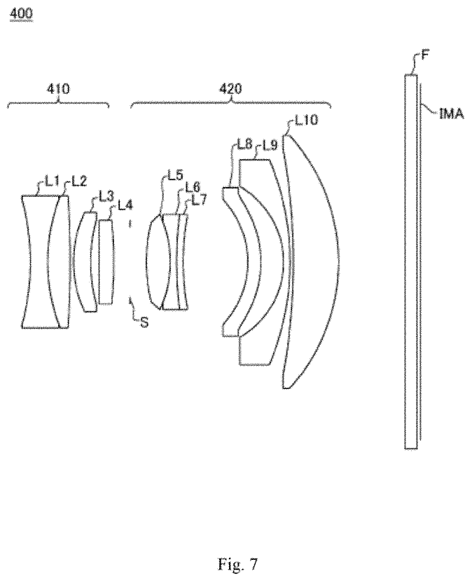

FIG. 7 shows lens structure, an optical member F, and an image surface IMA of the lens system 400 according to the fourth embodiment of the present disclosure. The lens system 400 consists essentially of a first lens group 410 having a positive refractive power, an aperture stop S, and a second lens group 420 having a positive refractive power in order from the object side. The first lens group 410, the aperture stop S, and the second lens group 420 can move in the optical axis direction as a whole to perform focusing. When focusing from the infinity focus state to the close object focus state, the first lens group 410 and the second lens group 420 may move from the image side to the object side with a fixed interval therebetween on the optical axis.

The first lens group 410 consists essentially of a cemented lens obtained by cementing a negative lens L1 and a positive lens L2, a positive lens L3, and a positive lens L4. The second lens group 420 consists essentially of a cemented lens obtained by cementing a positive lens L5, a negative lens L6, and a negative lens L7, a negative lens L8, a negative lens L9, and a positive lens L10. The optical member F is provided between the lens system 400 and the image plane IMA. For example, the optical member F is a filter, a cover plate, or the like. The light passing through the lens system 400 and the optical member F is incident on the image plane IMA.

Table 10 shows lens data of the lens system 400 according to one embodiment of the present disclosure. In Table 10, Di, Nd, and Vd are shown corresponding to the surface number i. The surface interval Di of the surface number 18 is a value when focusing at infinity.

TABLE 10

| SN | R | Di | Nd | Vd |
|---|---|---|---|---|
| 1 | −37.501 | 2.679 | 1.64769 | 33.84 |
| 2 | 28.146 | 3.462 | 1.65844 | 50.85 |
| 3 | −143.706 | 0.500 | | |
| 4* | 17.954 | 2.664 | 1.85135 | 40.10 |
| 5* | 26.325 | 1.296 | | |
| 6 | −618.747 | 2.241 | 1.90366 | 31.31 |
| 7 | −61.260 | 2.500 | | |
| STO | INF | 2.500 | | |
| 9 | 25.362 | 3.677 | 1.62041 | 60.34 |
| 10 | −17.576 | 1.000 | 1.60342 | 38.01 |
| 11 | 63.156 | 1.000 | 1.43700 | 95.10 |
| 12* | 39.971 | 9.965 | | |
| 13* | −14.239 | 2.000 | 1.85135 | 40.10 |
| 14 | −16.714 | 3.500 | | |
| 15 | −13.412 | 1.000 | 1.59270 | 35.45 |
| 16 | −40.859 | 0.500 | | |
| 17 | −97.660 | 6.937 | 1.80450 | 39.64 |
| 18 | −29.088 | 10.230 | | |
| 19 | INF | 1.850 | 1.51680 | 64.17 |
| 20 | INF | 0.500 | | |
| 21 | INF | 0.500 | | |

Table 11 shows surface numbers, conic constant κ, and aspheric coefficients A, B, C, and D of the surfaces having an aspherical shape of the lens system 400 according to one embodiment of the present disclosure. Regarding the values of the conic constant κ and the aspheric coefficients A, B, C, and D, “E-i” represents an exponential expression with a base of 10, that is, “10-i”. Among them, i is an integer.

TABLE 11

| SN | K | A | B | C | D |
|---|---|---|---|---|---|
| 4 | 0 | −1.248885E−08 | −5.258532E−05 | 6.502243E−10 | −5.868655E− |
| | | | | | 12 |
| 5 | 0 | 1.495460E−05 | −6.710121E−05 | 1.819948E−09 | −1.746664E− |
| | | | | | 11 |
| 13 | 0 | −5.038487E−05 | 5.359059E−07 | −3.841265E−09 | 3.755353E− |
| | | | | | 11 |
| 14 | 0 | −2.082916E−05 | 2.636605E−07 | 1.292921E−10 | 7.463921E− |
| | | | | | 12 |

Table 12 shows focal length f, Fno, half angle of view ω, maximum image height Y, and exit pupil position Dex of the entire system of the lens system 400 in the infinite focus state according to one embodiment of the present disclosure.

TABLE 12

| | |
|---|---|
| f | 45.23 |
| Fno | 4.07 |
| ω | 31.24 |
| Y | 27.5 |
| Dex | −42.64 |

The first lens group 410 consists essentially of a cemented lens having negative refractive power cementing a double-concave negative lens L1 and a positive lens L2, a positive aspheric meniscus lens L3 with a convex surface facing the object side, and a positive lens L4 having a shape with a larger radius of curvature on the object side than the image side. According to this configuration, the negative component comes first. As such, in a lens system with a small lens diameter, spherical aberration and off-axis aberration may be well corrected. In addition, by using a glass material whose Abbe number is larger than that of the negative lens L1 of the cemented lens for the positive lens L2 of the cemented lens, the axial chromatic aberration and the off-axis chromatic aberration can be well corrected.

The second lens group 420 consists essentially of a cemented lens having positive refractive power cementing a double-convex positive lens L5, a double-concave negative lens L6, and a negative lens L7 with a concave surface facing the image side, a negative aspheric meniscus lens L8 with a concave surface facing the object side, a negative meniscus lens L9 with a concave surface facing the object side, and a positive meniscus lens 10 with a concave surface facing the object side. A cemented lens is provided near the aperture stop S, and by using an aspheric meniscus lens L8, it is possible to appropriately correct aberrations for light of each angle of view, and to correct axial aberrations and off-axis aberrations in a balanced manner. In addition, by using a glass material with a very high Abbe number for one of the three cemented lenses, the on-axis chromatic aberration and off-axis chromatic aberration can be corrected well.

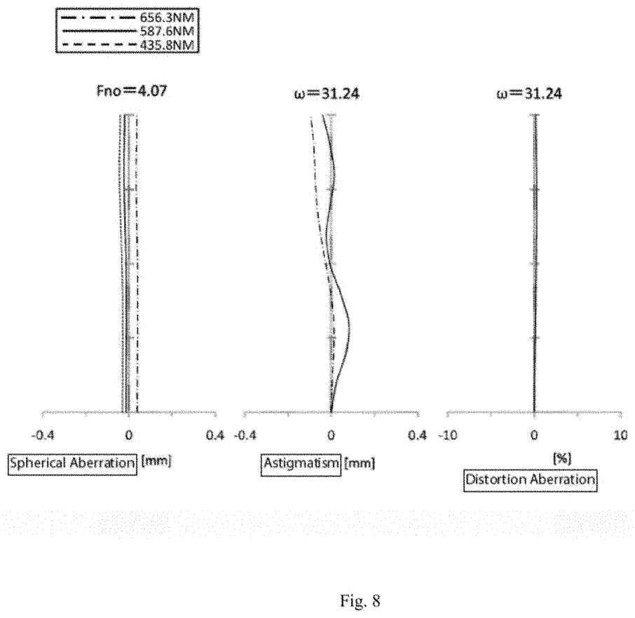

FIG. 8 shows spherical aberration, astigmatism, and distortion aberration in the infinite focus state of the lens system 400 according to one embodiment of the present disclosure. In spherical aberration, the dash-dotted line represents the value of the C line (656.27 nm), the solid line represents the value of the d line (587.56 nm), and the dotted line represents the value of the g line (435.84 nm). In astigmatism, the solid line represents the value of the sagittal image surface of the d-line, and the dash-dotted line represents the value of the meridian image surface of the d-line. The distortion aberration represents the value of the d-line. From the various aberration diagrams, it is obvious that various aberrations in the lens system 400 are well corrected and the lens system 400 has excellent imaging performance.

Table 13 shows numerical values involved in each Conditional Expressions in the first to fourth embodiments.

TABLE 13

| | Conditional | Conditional | Conditional | Conditional | Conditional | Conditional |
|---|---|---|---|---|---|---|
| | Expression | Expression | Expression | Expression | Expression | Expression |
| | 1 | 2 | 3 | 4 | 5 | 6 |
| Embodiment 1 | 0.86 | 2.18 | 1.48 | 0.79 | 0.10 | 10.10 |
| Embodiment 2 | 0.66 | 2.18 | 1.48 | 0.72 | 0.42 | 10.10 |
| Embodiment 3 | 0.99 | 2.18 | 1.59 | 0.24 | 0.25 | 10.10 |
| Embodiment 4 | 0.87 | 2.18 | 1.55 | 0.78 | 0.25 | 10.10 |

The lens system according to one embodiment of the present disclosure can be applied to lens systems for imaging devices such as digital cameras and video cameras. The lens system according to one embodiment of the present disclosure can be applied to a lens system that does not have a zoom mechanism. The lens system according to one embodiment of the present disclosure can also be applied to a lens system having a zoom mechanism. The lens system according to one embodiment of the present disclosure can be applied to an imaging lens included in a non-interchangeable lens type imaging device. The lens system according to one embodiment of the present disclosure can be applied to interchangeable lenses of interchangeable lens cameras such as single-lens reflex cameras.

Hereinafter, as an example of a system including the lens system according to one embodiment of the present disclosure, a moving body system will be described.

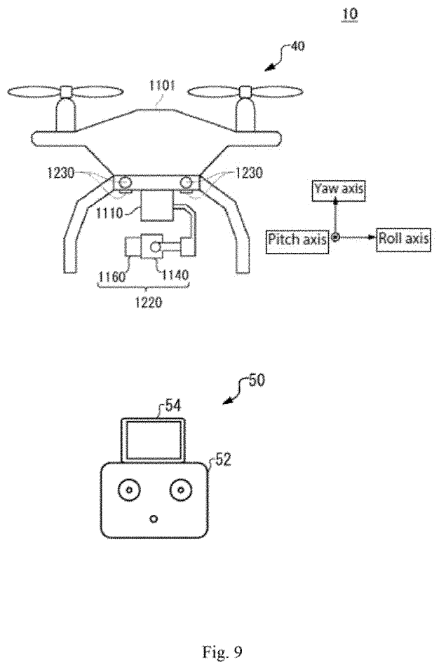

FIG. 9 schematically shows an example of a moving body system 10 including an unmanned aerial vehicle (UAV) 40 and a controller 50 according to one embodiment of the present disclosure. The UAV 40 includes a UAV main body 1101, a universal joint 1110, a plurality of camera devices 1230, and a photographing apparatus 1220. The photographing apparatus 1220 includes a lens device 1160 and an imaging unit 1140. The lens device 1160 includes the above-mentioned lens system according to one embodiment of the present disclosure. The UAV40 is an example of a moving body that includes the photographing apparatus having the above-mentioned lens system and moves. The moving body may include other aircrafts moving in the air, vehicles moving on the ground, and ships moving on the water in addition to UAVs.

The UAV main body 1101 may include a plurality of rotors. The UAV main body 1101 makes the UAV 40 fly by controlling rotation of the plurality of rotors. The UAV main body 1101 uses, for example, four rotors to fly the UAV 40. The number of rotors is not limited to four. UAV40 can also be a fixed-wing aircraft without rotors.

The camera device 1230 is an imaging camera that photographs a subject included in a desired imaging range. The plurality of camera devices 1230 may be sensing cameras that photograph surroundings of the UAV 40 in order to control the flight of the UAV 40. The camera devices 1230 may be fixed on the UAV main body 1101.

The two camera devices 1230 can be installed on the nose of the UAV 40, that is, on the front side. In addition, the other two camera devices 1230 can be installed on the bottom surface of the UAV 40. The two camera devices 1230 on the front side can be paired to function as a so-called a stereo camera. The two camera devices 1230 on the bottom side can also be paired to function as a stereo camera. The three-dimensional spatial data around the UAV 40 can be generated based on the images taken by the plurality of camera devices 1230. The distance to the subject captured by the plurality of imaging devices 1230 can be determined by the stereo cameras of the plurality of camera devices 1230.

The number of camera devices 1230 included in the UAV 40 is not limited to four. The UAV40 only needs to include at least one camera device 1230. The UAV40 may be equipped with at least one camera device 1230 on the nose, tail, side, bottom, and top surfaces of the UAV40, respectively. The camera device 1230 may also have a single focus lens or a fisheye lens. In the description related to UAV40, the plurality of camera devices 1230 may simply be collectively referred to as camera devices 1230.

The controller 50 may include a display unit 54 and an operation unit 52. The operation unit 52 may receive an input operation for controlling the posture of the UAV 40 from the user. The controller 50 may transmits a signal for controlling the UAV 40 in accordance with the user's operation received by the operation unit 52.

The controller 50 may receive an image captured by at least one of the camera devices 1230 and the photographing apparatus 1220. The display section 54 displays the image received by the controller 50. The display section 54 may be a touch panel. The controller 50 may receive input operations from the user through the display section 54. The display section 54 can receive a user operation or the like in which the user designates a position of a subject to be captured by the photographing apparatus 1220.

The imaging unit 1140 generates and records image data of an optical image formed by the lens device 1160. The lens device 1160 may be integrally provided on the imaging unit 1140. The lens device 1160 may be a so-called interchangeable lens. The lens device 1160 can be detachably installed on the imaging unit 1140.

The universal joint 1110 may have a supporting mechanism that movably supports the photographing apparatus 1220. The photographing apparatus 1220 may be mounted on the UAV main body 1101 through the universal joint 1110. The universal joint 1110 may rotatably support the photographing apparatus 1220 around the pitch axis. The universal joint 1110 may rotatably support the photographing apparatus 1220 with the roll axis as the center. The universal joint 1110 may rotatably support the photographing apparatus 1220 around the yaw axis. The universal joint 1110 can rotatably support the photographing apparatus 1220 around at least one of the pitch axis, the roll axis, and the yaw axis. The universal joint 1110 can rotatably support the photographing apparatus 1220 around the pitch axis, the roll axis, and the yaw axis, respectively. The universal joint 1110 may also hold the imaging unit 1140. The universal joint 1110 may also hold the lens device 1160. The universal joint 1110 can rotate the imaging unit 1140 and the lens device 1160 around at least one of the yaw axis, the pitch axis, and the roll axis, thereby changing the imaging direction of the photographing apparatus 1220.

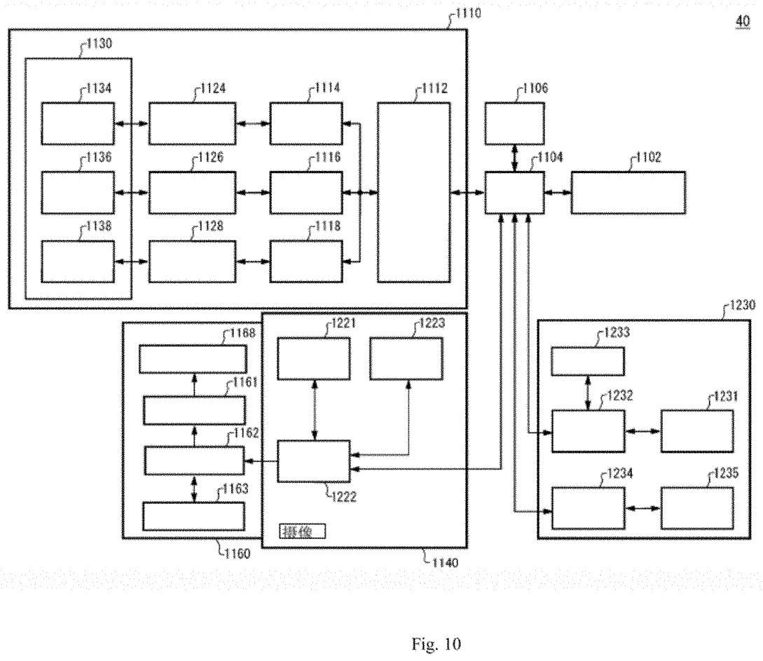

FIG. 10 shows an example of functional blocks of UAV40 according to one embodiment of the present disclosure. The UAV 40 includes an interface 1102, a control unit 1104, a memory 1106, a universal joint 1110, an imaging unit 1140, and a lens device 1160.

The interface 1102 may communicate with the controller 50. The interface 1102 may receive various instructions from the controller 50. The control unit 1104 may control the flight of the UAV 40 in accordance with instructions received from the controller 50. The control unit 1104 may control the universal joint 1110, the imaging unit 1140, and the lens device 1160. The control unit 1104 may be composed of a microprocessor such as a CPU or an MPU, a microcontroller such as an MCU, or the like. The memory 1106 may store programs and the like necessary for the control unit 1104 to control the universal joint 1110, the imaging unit 1140, and the lens device 1160.

The memory 1106 may be a computer-readable recording medium. The memory 1106 may include at least one of flash memory such as SRAM, DRAM, EPROM, EEPROM, and USB memory. The memory 1106 may be provided in the housing of the UAV40. It can be set to be detachable from the UAV40 housing.

The universal joint 1110 may include a control part 1112, a driver 1114, a driver 1116, a driver 1118, a driving part 1124, a driving part 1126, a driving part 1128 and a supporting mechanism 1130. The driving part 1124, the driving part 1126, and the driving part 1128 may be electric motors.

The supporting mechanism 1130 may support the photographing apparatus 1220. The supporting mechanism 1130 may movably support the photographing apparatus 1220 in the imaging direction. The supporting mechanism 1130 may rotatably support the imaging unit 1140 and the lens device 1160 around the yaw axis, the pitch axis, and the roll axis. The supporting mechanism 1130 may include a rotation mechanism 1134, a rotation mechanism 1136, and a rotation mechanism 1138. The rotation mechanism 1134 may rotate the imaging unit 1140 and the lens device 1160 around the yaw axis through the drive part 1124. The rotation mechanism 1136 may rotate the imaging unit 1140 and the lens device 1160 with the pitch axis as the center through the driving part 1126. The rotation mechanism 1138 may rotate the imaging unit 1140 and the lens device 1160 around the roll axis through the drive part 1128.

The control part 1112 may output to the driver 1114, the driver 1116, and the driver 1118 an operation command indicating the respective rotation angles in accordance with the operation command of the universal joint 1110 from the control unit 1104. The driver 1114, the driver 1116, and the driver 1118 may drive the driving part 1124, the driving part 1126, and the driving part 1128 in accordance with an operation command indicating the rotation angle. The rotation mechanism 1134, the rotation mechanism 1136, and the rotation mechanism 1138 may be respectively driven and rotated by the drive part 1124, the drive part 1126, and the drive part 1128, thereby changing postures of the imaging unit 1140 and the lens device 1160.

The imaging unit 1140 may use light passing through the lens system 1168 to perform imaging. The imaging unit 1140 may include a control part 1222, an imaging element 1221, and a memory 1223. The control part 1222 may be composed of a microprocessor such as a CPU or an MPU, a microcontroller such as an MCU, or the like. The control part 1222 may control the imaging unit 1140 and the lens device 1160 in accordance with the operation instructions for the imaging unit 1140 and the lens device 1160 from the control unit 1104. The control part 1222 may output a control command for the lens device 1160 to the lens device 1160 according to the signal received from the controller 50. The control instruction may be an instruction to vibrate the lens system 1168 or an instruction to detect a temperature of the lens system 1168.

The memory 1223 may be a computer-readable recording medium and may include at least one of flash memory such as SRAM, DRAM, EPROM, EEPROM, and USB memory. The memory 1223 may be provided inside the housing of the imaging unit 1140. The imaging unit 1140 may be configured to be detachable from the housing.

The imaging element 1221 may be held inside the housing of the imaging unit 1140, generate image data of an optical image formed by the lens device 1160, and output the image data to the control part 1222. The control part 1222 may store the image data output from the imaging element 1221 in the memory 1223. The control part 1222 may output the image data to the memory 1106 through the control unit 1104 for storage.

The lens device 1160 may include a control unit 1162, a memory 1163, a driving mechanism 1161, and a lens system 1168. The lens system according to the above-mentioned embodiment of the present disclosure can be applied as the lens system 1168.

The control unit 1162 can drive the lens system 1168 according to a control command from the control part 1222. The driving mechanism 1161 can move the plurality of lens groups and the aperture stop included in the lens system 1168 in the optical axis direction according to a control command from the control unit 1162, thereby adjusting the focus of the lens system 1168. The driving mechanism 1161 can control the aperture stop included in the lens system 1168 according to a control command from the control unit 1162. The driving mechanism 1161 can vibrate the lens system 1168 in accordance with a control command from the control unit 1162. The driving mechanism 1161 includes, for example, an actuator and the like. The image formed by the lens system 1168 of the lens device 1160 may be captured by the imaging unit 1140.

The lens device 1160 may be integrally provided on the imaging unit 1140. The lens device 1160 may be a so-called interchangeable lens. The lens device 1160 can be detachably installed in the imaging unit 1140.

The camera device 1230 may include a control unit 1232, a control unit 1234, an imaging element 1231, a memory 1233, and a lens 1235. The control unit 1232 may be composed of a microprocessor such as a CPU or an MPU, a microcontroller such as an MCU, or the like. The control unit 1232 may control the imaging element 1231 in accordance with the operation command for the imaging element 1231 from the control unit 1104.

The control unit 1234 may be composed of a microprocessor such as a CPU or an MPU, a microcontroller such as an MCU, or the like. The control unit 1234 can adjust the focus of the lens 1235 in accordance with the operation instruction for the lens 1235. The control unit 1234 can control the aperture stop of the lens 1235 in accordance with an operation command for the lens 1235.

The memory 1233 may be a computer-readable recording medium. The memory 1233 may include at least one of flash memory such as SRAM, DRAM, EPROM, EEPROM, and USB memory.

The imaging element 1231 may generate image data of an optical image formed by the lens 1235, and output it to the control unit 1232. The control unit 1232 may store the image data output from the imaging element 1231 in the memory 1233.

In this embodiment, the UAV 40 may include a control unit 1104, a control unit 1112, a control unit 1222, a control unit 1232, a control unit 1234, and a control unit 1162. However, the processing executed by a plurality of the control unit 1104, the control unit 1112, the control unit 1222, the control unit 1232, the control unit 1234, and the control unit 1162 may be executed by any one control unit. The processing executed by the control unit 1104, the control unit 1112, the control unit 1222, the control unit 1232, the control unit 1234, and the control unit 1162 may also be executed by one control unit. In this embodiment, the UAV 40 includes a memory 1106, a memory 1223, and a memory 1233. The information stored in at least one of the memory 1106, the memory 1223, and the memory 1233 may be stored in one or more other memories among the memory 1106, the memory 1223, and the memory 1233.

The photographing apparatus 1220 may include the lens device 1160 having the lens system according to the above-mentioned embodiment of the present disclosure, so that it is possible to provide a compact imaging function with high optical performance.

Hereinafter, as an example of a system including the lens system according to an above-mentioned embodiment of the present disclosure, a stabilizer will be described.

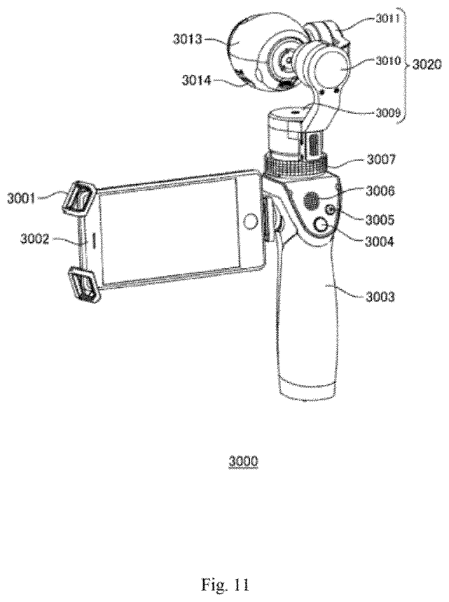

FIG. 11 is an external perspective view showing an example of a stabilizer 3000 according to one embodiment of the present disclosure. The stabilizer 3000 is another example of a moving body. For example, the camera unit 3013 included in the stabilizer 3000 may include an imaging device having the same structure as the photographing apparatus 1220. The camera unit 3013 may include a lens device having the same structure as the lens device 1160.

The stabilizer 3000 may include a camera unit 3013, a universal joint 3020, and a handle 3003. The universal joint 3020 may rotatably support the camera unit 3013. The universal joint 3020 may have a translation shaft 3009, a roll shaft 3010, and a tilt shaft 3011. The universal joint 3020 may rotatably support the camera unit 3013 centered on the translation shaft 3009, the roll shaft 3010, and the tilt shaft 3011. The universal joint 3020 is an example of a supporting mechanism.

The camera unit 3013 is an example of an imaging device. The camera unit 3013 may have a slot 3014 into which a memory is inserted. The universal joint 3020 may be fixed on the handle 3003 by a bracket 3007.

The handle 3003 may have various buttons for operating the universal joint 3020 and the camera unit 3013. The handle 3003 may include a shutter button 3004, a recording button 3005, and an operation button 3006. By pressing the shutter button 3004, a still image can be recorded by the camera unit 3013. By pressing the recording button 3005, a moving image can be recorded by the camera unit 3013.

The device holder 3001 may be fixed on the handle 3003. The device holder 3001 may hold a mobile device 3002 such as a smart phone. The mobile device 3002 may be communicably connected with the stabilizer 3000 through a wireless network such as WiFi. Thereby, the image taken by the camera unit 3013 can be displayed on the screen of the mobile device 3002.

In the stabilizer 3000, the camera unit 3013 may also include the lens system according to the above-mentioned embodiment of the present disclosure, so that it is possible to provide a compact imaging function with high optical performance.

In the above, as examples of a moving body, the UAV40 and the stabilizer 3000 have been exemplified. The camera device having the same structure as the photographing apparatus 1220 can be mounted on a moving body other than the UAV40 and the stabilizer 3000.

As for the execution order of each process in the device, system, program and method shown in the claims, specification and drawings, as long as it does not clearly indicate “before” or “before . . . ” Etc., or when the output of the previous processing is not to be used in the subsequent processing, it can be implemented in any order. Regarding the operating procedures in the claims, the specification, and the drawings in the specification, the description is made using “first,” “next,” etc. for convenience, but it does not mean that it must be implemented in this order.

In the description of the present disclosure, it should be understood that the terms “center,” “longitudinal,” “transverse,” “length,” “width,” “thickness,” “upper,” “lower,” “front,” “back,” “left,” “right,” “vertical,” “horizontal,” “top,” “bottom,” “inner,” “outer,” “clockwise,” “counterclockwise,” “axial,” “radial,” “circumferential,” etc. indicate orientation or positional relationship based on the orientation or positional relationship shown in the drawings, and are only for the convenience of describing the present disclosure and simplifying the description, and do not indicate or imply that the referred device or element must have a specific orientation, be constructed and operated in a specific orientation, and therefore cannot be understood as a limitation of the present disclosure.

It should be noted that in the description of the present disclosure, the terms “first” and “second” are only used to facilitate description of different components and cannot be understood as indicating or implying the order relationship, relative importance or implicitly indicating the quantity of the indicated technical characteristics. Therefore, the features defined with “first” and “second” may explicitly or implicitly include at least one of the features.

In the present disclosure, unless expressly specified otherwise, the terms “installed,” “connected,” “coupled,” “fixed” and other terms should be interpreted broadly. For example, it may be a fixed connection or a detachable connection, or integrally formed, which can be mechanically connected, or electrically connected, or can communicate with each other. It can be directly connected or indirectly connected through an intermediate medium, and it can be the internal communication between two components or the interaction between the two components, unless there are other clear restrictions. For those of ordinary skill in the art, the specific meaning of the above-mentioned terms in the present disclosure can be understood according to specific circumstances.

Finally, it should be noted that the above embodiments are only used to illustrate the technical solutions of the present disclosure, not to limit them; although the present disclosure has been described in detail with reference to the foregoing embodiments, those of ordinary skill in the art should understand that the technical solutions recorded in the foregoing embodiments can still be modified, or some or all of the technical features can be equivalently replaced. However, these modifications or replacements do not cause the essence of the corresponding technical solutions to deviate from the scope of the technical solutions of the embodiments of the present disclosure.

What is claimed is:

1. A lens system consisting essentially of a first lens group having positive refractive power, an aperture stop, and a second lens group having positive refractive power in order from an object side to an image side;
wherein when focusing from an infinity focus state to a close object focus state, the first lens group and the second lens group are configured to move from the image side to the object side with a fixed interval between the first lens group and the second lens group on an optical axis;
the first lens group consists essentially of three or more lenses, which include one or more cemented lenses and one aspherical meniscus lens with a convex surface facing the object side in order from the object side;
the second lens group consists essentially of more than four lenses, which include one or more cemented lens and one aspherical meniscus lens with a concave surface facing the object side in order from the object side; and
the lens system satisfies Conditional Expressions 1 and 2:
0.5<f/f1<1.1 (Conditional Expression 1),
1.9<TL/Y<2.4 (Conditional Expression 2).
wherein f is a focal length of the lens system; f1 is a focal length of the first lens group; TL is a distance on the optical axis from a lens surface closest to the object side of the first lens group to an imaging plane in the infinite focus state with a back focal length being in air conversion length; and Y is a maximum image height.

2. The lens system according to claim 1, wherein the lens system further satisfies Conditional Expression 3:
1.3<EPD/Y<1.7 (Conditional Expression 3),
wherein EPD is an exit pupil distance.

3. The lens system according to claim 1, wherein the lens system further satisfies Conditional Expressions 4 and 5:

|f/f_1asp|<1.0 (Conditional Expression 4),

|f/f_2asp|<1.0 (Conditional Expression 5),
wherein f_1asp is a focal length of the aspheric meniscus lens included in the first lens group and f_2asp is a focal length of the aspheric meniscus lens included in the second lens group.

4. The lens system according to claim 1, wherein the lens system further satisfies Conditional Expression 6:

|CR_r1/CR_r2|>5 (Conditional Expression 6),
wherein CR_r1 is a radius of curvature of an object side of a lens closest to the image side of the first lens group and CR_r2 is a radius of curvature of an image side of the lens closest to the image side of the first lens group.

5. The lens system according to claim 1, wherein the lens system satisfies Conditional Expressions 1-1 and 2-1:
0.65<f/f1<1.0 (Conditional Expression 1-1),
2.1<TL/Y<2.3 (Conditional Expression 2-1).

6. The lens system according to claim 2, wherein the lens system further satisfies Conditional Expression 3-1:
1.4<EPD/Y<1.6 (Conditional Expression 3-1).

7. The lens system according to claim 3, wherein the lens system further satisfies Conditional Expressions 4-1 and 5-1:

|f/f_1asp|<0.8 (Conditional Expression 4-1),

|f/f_2asp|<0.6 (Conditional Expression 5-1).

8. The lens system according to claim 4, wherein the lens system further satisfies Conditional Expression 6-1:

|CR_r1/CR_r2|>10 (Conditional Expression 6-1).

9. The lens system according to claim 1, wherein the first lens group consists essentially of a cemented lens having negative refractive power cementing a double-concave negative lens L1 and a positive lens L2, the aspheric meniscus lens L3 having positive refractive power with the convex surface facing the object side, and a positive lens L4 having a shape with a larger radius of curvature on the object side than the image side.

10. The lens system according to claim 9, wherein the positive lens L2 of the cemented lens in the first lens group is made of a glass material with a larger Abbe number than that of the negative lens L1 of the cemented lens.

11. The lens system according to claim 9, wherein the second lens group consists essentially of a cemented lens having positive refractive power cementing a biconvex positive lens L5 and a biconcave negative lens L6, the aspheric meniscus lens L7 having negative refractive power with the concave surface facing the object side, a negative meniscus lens L8 with a concave surface facing the object side and a positive meniscus lens L9 with a concave surface facing the object side.

12. The lens system according to claim 11, wherein the positive lens L5 of the cemented lens in the second lens group is made of a glass material with a larger Abbe number than that of the negative lens L6 of the cemented lens.

13. The lens system according to claim 9, wherein the second lens group consists essentially of a cemented lens having positive refractive power cementing a double-convex positive lens L5, a double-convex positive lens L6 and a double-concave negative lens L7, the aspheric meniscus lens L8 having negative refractive power with the concave surface facing the object side, a negative meniscus lens L9 with a concave surface facing the object side, and a positive meniscus lens L10 with a concave surface facing the object side.

14. The lens system according to claim 13, wherein the positive lens L6 of the cemented lens in the second lens group is made of a glass material with a larger Abbe number than that of the negative lens L7 of the cemented lens.

15. The lens system according to claim 9, wherein the second lens group consists essentially of a cemented lens having positive refractive power cementing a biconvex positive lens L5 and a biconcave negative lens L6, the aspheric meniscus lens L7 having negative refractive power with a concave surface facing the object side, a negative meniscus lens L8 with a concave surface facing the object side, and another cemented lens having positive refractive power cementing a double-concave negative lens L9 and a double-convex positive lens L10.

16. The lens system according to claim 15, wherein the positive lens L5 of the cemented lens in the second lens group is made of a glass material with a larger Abbe number than that of the negative lens L6 of the cemented lens.

17. The lens system according to claim 9, wherein the second lens group consists essentially of a cemented lens having positive refractive power cementing a double-convex positive lens L5, a double-concave negative lens L6, and a negative lens L7 with a concave surface facing the image side, the negative aspheric meniscus lens L8 with the concave surface facing the object side, a negative meniscus lens L9 with a concave surface facing the object side, and a positive meniscus lens 10 with a concave surface facing the object side; and
the positive lens L5 of the cemented lens in the second lens group is made of a glass material with a larger Abbe number than that of the negative lens L6 and that of the negative lens L7 of the cemented lens.

18. A photographing apparatus, comprising the lens system according to claim 1 and an imaging unit.

19. A moving body comprising the lens system according to claim 1 and configured to move.

20. The moving body according to claim 19, wherein the moving body is an unmanned aerial vehicle or a stabilizer.
